(19) United States
(12) Patent Application Publication
(10) Pub. No.: US 2026/0194152 A1
(43) Pub. Date: Jul. 9, 2026

(54) FLUID VALVE ASSEMBLY

(71) Applicant: Checkfluid Inc., London (CA)

(72) Inventor: Bernard HALL, London (CA)

(73) Assignee: Checkfluid Inc., London (CA)

(21) Appl. No.: 19/421,394

(22) Filed: Dec. 16, 2025

Related U.S. Application Data
(60) Provisional application No. 63/742,705, filed on Jan. 7, 2025.

(51) Int. Cl. F16K 15/06; G01N 1/10; G01N 1/40

(52) U.S. Cl. CPC F16K 15/066; G01N 1/10; G01N 1/4077; G01N 2001/4088

(57) ABSTRACT

A fluid valve assembly for engagement with a fluid port has a valve assembly body with nested valves. One of the valves can be used in conjunction with a sampling device for sampling working fluid from the fluid port while the other of the valves can be used for other fluid handling operations, such as filtering and recycling working fluid from the fluid port back into a machine in which the working fluid is used. A magnet at an inlet aperture of the assembly prevents magnetic particles from clogging the sampling valve. The valve assembly can be used for both sampling and other fluid handling operations without having to remove the valve assembly from the fluid port.

### CROSS REFERENCE TO RELATED APPLICATIONS

This application claims the benefit of Unites States Provisional Patent Application No. 63/742,705, filed January 7, 2025, the entire contents of which are herein incorporated by reference.

### FIELD

This application relates to fluid valves, in particular to a valve assembly for fluid sampling and other fluid handling operations.

### BACKGROUND

Sampling of working fluids of industrial machines is often required for preventative maintenance and/or quality control. In some industrial machines, for example the gearboxes of mining equipment, the accumulation of particulate matter in the working fluid can be particularly omnipresent, in which case periodic or continuous filtration of the working fluid is also desirable. Filtration of the working fluid and sampling of the working fluid can be done by separate devices, each containing their own valve and fluid port fitting, thereby requiring removal of a filtration device from a fluid port of the industrial machine and insertion of a sampling device into the fluid port, or vice-versa. Alternatively, the filtration device may remain connected to the fluid port and samples of the filtered working fluid can be taken by the sampling device from the filtration device, however, such an operation does not provide a true state of the working fluid in the industrial machine.

There remains a need for a fluid valve assembly that can be used for both sampling and other fluid handling operations (e.g., filtering) in industrial machines without having to remove the valve assembly from a fluid port of the industrial machine.

### SUMMARY

A fluid valve assembly comprises: a valve assembly body having an internal cavity with a fluid flow path from a first end to a second end of the path, the valve assembly body at the first end configured to sealingly engage a fluid port from which a working fluid flows, the first end of the fluid flow path comprising an inlet aperture through which the working fluid flows into the internal cavity, the valve assembly body at the second end configured to sealingly engage a fluid handling device, the second end of the fluid flow path having an outlet aperture through which the working fluid flows out of the internal cavity; a first valve comprising: a first valve body movably disposed in the internal cavity; and, a first biasing element that biases the first valve body to sealingly seat the first valve body on a first seat in the internal cavity to prevent the working fluid in the internal cavity from flowing out the outlet aperture, the first valve body movable against the bias of the first biasing element to unseat the first valve body from the seat to permit the working fluid in the internal cavity to flow out the outlet aperture, the first valve body having a bore therethrough that fluidly connects the inlet aperture to the outlet aperture; a second valve comprising: a second valve body movably disposed in the bore of the first valve body; and, a second biasing element that biases the second valve body to sealingly seat the second valve body on a second seat in the bore to prevent the working fluid in the bore from flowing out the outlet aperture, the second valve body movable against the bias of the second biasing element to unseat the second valve body from the second seat to permit the working fluid in the bore to flow out the outlet aperture.

A system for fluid handling operations at a fluid port of a fluid-containing machine or container comprises the fluid valve assembly described above and a probe of a fluid handling device, the probe sealingly engaged with the valve assembly body at the second end of the fluid flow path, the probe sealingly engageable with a remaining portion of the fluid handling device.

The fluid valve assembly comprises a valve assembly body with nested valves disposed within the internal cavity. The internal cavity defines a fluid flow path having a first end where the inlet aperture is located to a second end where the outlet aperture is located. The first and second valves are located in the fluid flow path. The first valve controls fluid flow through a first portion of the fluid flow path between the first valve body and a wall of the internal cavity. The second valve controls fluid flow through a second portion of the fluid flow path through the bore of the first valve body. Whether the working fluid follows the first portion or the second portion of the fluid flow path through the internal cavity of the assembly, the working fluid enters the assembly through the inlet aperture and exits the assembly through the outlet aperture. Thus, both the first and second valves are in fluid communication with the inlet and outlet apertures during operation of the valves. The fluid valve assembly is therefore very compact and suitable for use on small fluid ports in tight spaces. Further, the fluid valve assembly is a single acting valve assembly providing freer fluid flow in comparison to common double acting hydraulic quick couplings where a second valve can partially restrict fluid flow.

The valve bodies can be any suitable size and shape provided that a bore can be provided through the first valve body, and the second valve body can fit and move within the bore. In some embodiments, the first valve body comprises a plunger. In some embodiments, the second valve body comprises a ball. In some embodiments, the first biasing element and/or the second biasing element comprises a spring, for example a coil spring, a leaf spring, a spiral spring, a disc spring, and the like. In some embodiments, the first biasing element and/or the second biasing element comprises a coiled spring. In some embodiments, both the first biasing element and the second biasing element comprise coiled springs.

In some embodiments, the biasing elements are seated on respective valve bodies and seated against one or more non-movable portions of the valve assembly body. In some embodiments, the one or more non-movable portions of the valve assembly body comprises a retainer at the inlet aperture against which the first and second biasing elements are seated. In some embodiments, the retainer comprises a disc spanning a diameter of the inlet aperture. In some embodiments, the disc has solid portions on which the first and second biasing elements are seated and open portions through which the working fluid flows into the internal cavity of the valve assembly body and the bore of the first valve body.

The biasing elements urge the respective valve bodies toward respective valve body seats where the valve bodies are sealingly engaged in closed configurations to prevent fluid flow through the valves. To open a valve, force is applied to the valve body from an outlet side of the valve, which urges the valve body against the biasing element and moves the valve body away from the valve seat to an open configuration, which opens the fluid flow path toward the outlet aperture. Releasing the force permits the biasing element to urge the valve body back onto the valve seat to close the valve. In some embodiments, the force required to open the valves is supplied by a probe of a fluid handling device. In some embodiments, the valve assembly body is configured at the outlet aperture to engage the probe of the fluid handling device. The probe comprises a valve body engagement element that applies force to the outlet side of the valve body when the fluid handling device is connected to the valve assembly body at the outlet aperture thereby opening the valve. Disconnecting the fluid handling device from the valve assembly body disengages the valve body engagement element from the valve body thereby permitting the valve to close.

In some embodiments, the valve assembly body is cylindrical at the first and second ends. In some embodiments, the valve assembly body has first external screw threads around a side face at the first end of the fluid valve assembly to screw into complementary threads of the fluid port. In some embodiments, the valve assembly body has second external screw threads around the side face at the second end of the fluid valve assembly to screw into complementary threads of the fluid handling device. In some embodiments, the valve assembly body has a flat end face for flush face engagement with the fluid handling device. The flat end face is easily wipeable, helping to prevent ingress of contamination during fluid handling processes.

Fluid handling devices include, for example, a sampling device, a filtration device, a general purpose fluid conveying device, and the like.

In some embodiments, the fluid handling device comprises a sampling device having a bottle sealingly engageable with the probe. In some embodiments, the probe of the sampling device has a flat face for flush face engagement with the flat end face of the valve assembly body. In some embodiments, the flush face engagement is sealed with a face seal (e.g., a gasket) on the flat face of the probe. In some embodiments, the probe of the sampling device has a tube extending from the flat face that acts as a valve body engagement element to engage the second valve body to open the second valve. The tube is inserted through the outlet aperture and comprises an opening at or near the end so that working fluid flowing in the bore can flow into the tube and thence into the bottle of the sampling device. In this embodiment, the second valve is called a sampling valve.

In some embodiments, the fluid handling device comprises a filtration device having a particle filter sealingly engageable with the probe. In some embodiments, the filtration device comprises a fluid return sealingly engageable to another fluid port of the fluid-containing machine or a container. In some embodiments, the probe of the filtration device has a stem that acts as a valve body engagement element to engage the first valve body to open the first valve. Working fluid then flows between the first valve body, which has been unseated by the stem of the probe, and the wall of the internal cavity to pass through the outlet aperture into the filtration device.

In some embodiments, the fluid valve assembly comprises a cap for covering the outlet aperture when a fluid handling device is not engaged with valve assembly body.

The fluid valve assembly comprises various seals to prevent leakage of working fluid. Any suitable seals can be used depending on the application and seal configuration required. In some embodiments, the seals comprise o-rings, gaskets or the like. Sealing around the valve bodies at their respective valve seats is preferably accomplished with o- rings. In some embodiments, the seal for the second valve body is held in place around the bore of the first valve body by a snap ring inserted onto a press fit at the outlet aperture.

In some embodiments, the fluid valve assembly further comprises a magnet situated at the inlet aperture. Fluid ports on industrial machines are generally quite small having diameters less than a few tens of millimeters. Thus, the valve assembly is correspondingly small and the second valve even smaller. The second portion of the fluid flow path can have a diameter of less than a few millimeters. Especially in industrial operations, the working fluid in the machine can become contaminated with magnetic particles, for example ferrous particles that abrade off internal machine parts during operation of the machine. The magnet prevents magnetic particles from clogging the second valve by collecting the magnetic particles at the inlet aperture before the particles enter the second valve. The magnet can form, or be in, a portion or all of the wall around the inlet aperture. In some embodiments, the magnet is annular and surrounds a perimeter of the inlet aperture.

The fluid valve assembly is particularly useful on industrial machines (e.g., gearboxes, engines and the like) that contain a working fluid that requires fluid handling operations, such as periodic sampling, transferring, filtering and/or recycling working fluid from the fluid port back into the machine in which the working fluid is used. One of the valves in the valve assembly can be used in conjunction with a sampling device for sampling the working fluid from the fluid port while the other of the valves can be used for other fluid handling operations. As such, the valve assembly can be used for both sampling and other fluid handling operations without having to remove the valve assembly from the fluid port. In some embodiments, the working fluid is oil, for example hydraulic oil, engine oil, transmission oil and the like. However, the fluid valve assembly can be used with any type of working fluid including water and aqueous solutions.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a side cut-away view of a fluid valve assembly.

FIG. 2A depicts a perspective from an outlet aperture end of the fluid valve assembly of FIG. 1.

FIG. 2B depicts a perspective from an inlet aperture end of the fluid valve assembly of FIG. 1.

FIG. 3 depicts a side cut-away view of a system for fluid handling operations, the system comprising the fluid valve assembly of FIG. 1 and a probe of a sampling device.

FIG. 4 depicts a side cut-away view of a system for fluid handling operations, the system comprising the fluid valve assembly of FIG. 1 and a probe of a filtration device.

FIG. 5 depicts a side cut-away view of a system for fluid handling operations, the system comprising the fluid valve assembly of FIG. 1 and a probe of a general purpose fluid conveying device.

FIG. 6 depicts a side cut-away view of the fluid valve assembly of FIG. 1 with a cap over an outlet aperture of the fluid valve assembly.

### DETAILED DESCRIPTION

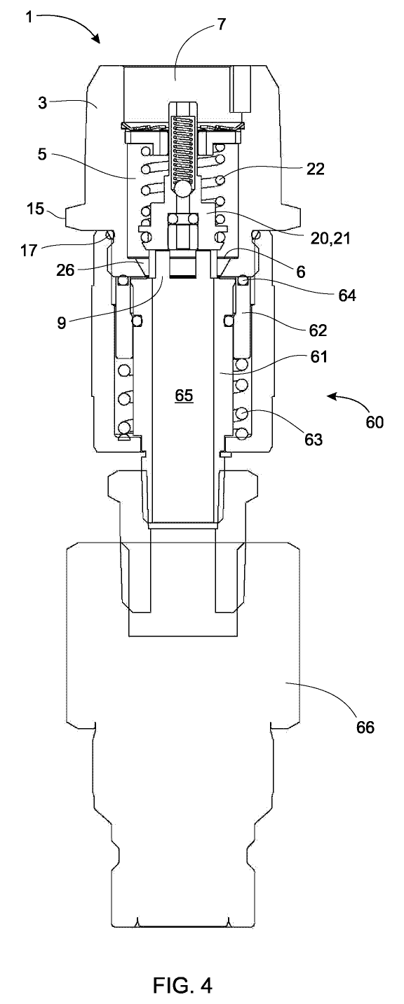

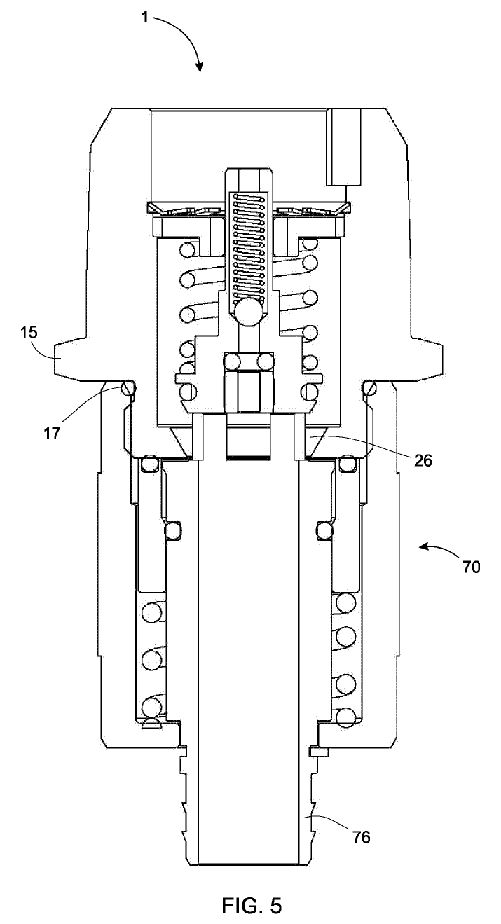

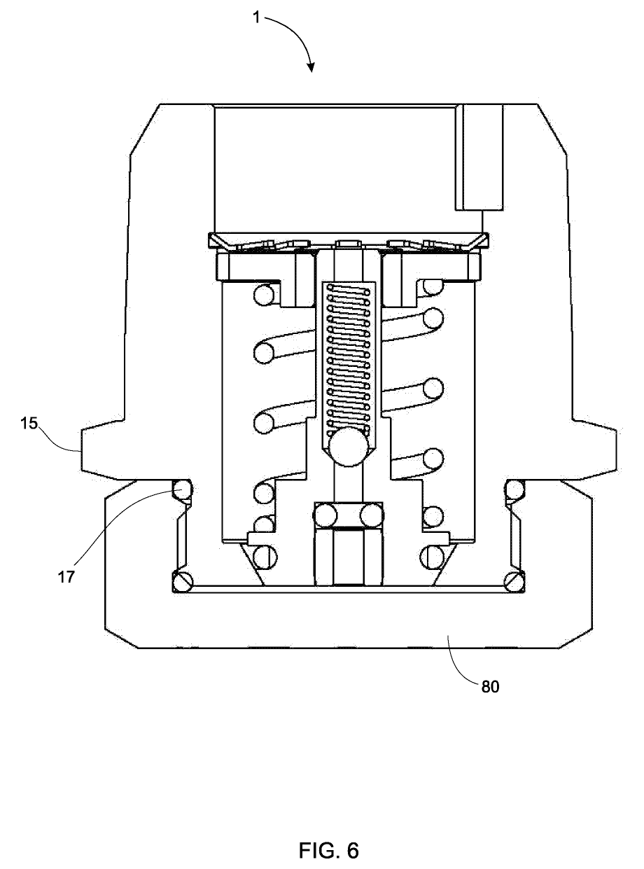

With reference to the Figures, a fluid valve assembly 1 comprises a cylindrical valve assembly body 3 having an internal cavity 5 that defines a fluid flow path between an inlet aperture 7 at a first end of the fluid flow path and an outlet aperture 9 at a second end of the fluid flow path. The valve assembly body 3 comprises a flat end face 10 around the outlet aperture 9. The cylindrical valve assembly body 3 has first external screw threads 11 at the inlet aperture 7 for engagement with complementary screw threads of a fluid port of a machine (e.g., a gearbox) and second external screw threads 13 at the outlet aperture 9 for engagement with complementary screw threads on a fluid handling device (e.g., a probe of a fluid handling device). Between the screw threads 11 and 13, the valve assembly body 3 has a perimetrical external hexagonal wrench grip 15 for engagement with a wrench to tighten the fluid valve assembly 1 in the fluid port. An external o-ring 17 located between the wrench grip 15 and the second external screw threads 13 provides a redundant seal to prevent leakage when a cap 80 (see FIG. 6) or fluid handling probes (see FIG. 4 and FIG. 5) are screwed on to the second external screw threads 13. The fluid valve assembly 1 further comprises a magnet 19 embedded in a portion of an interior of a perimetrical wall 8 of the valve assembly body 3 surrounding the inlet aperture 7.

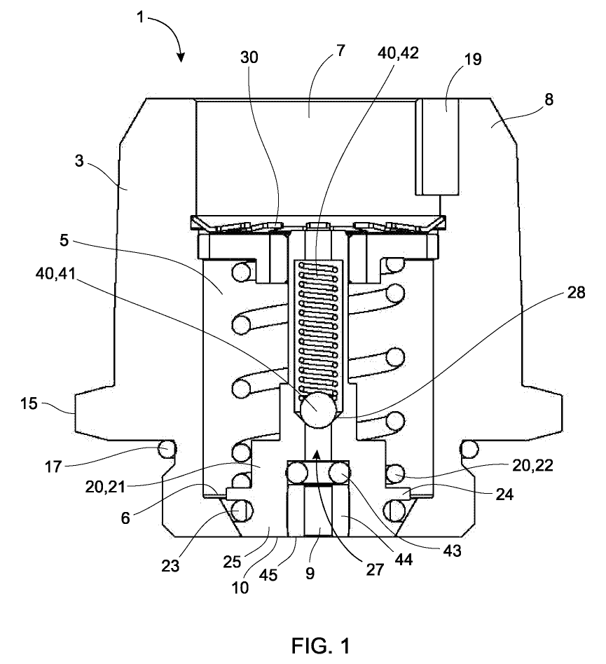

In the internal cavity 5, the fluid valve assembly 1 further comprises a first valve 20, the first valve 20 comprising a plunger 21, with a first coiled compression spring 22 seated on a perimetrical shoulder 24 of the plunger 21. In a closed configuration as illustrated in FIG. 1, the plunger 21 is seated on an inwardly extending portion of a wall 6 of the internal cavity 5 to block a fluid flow path 26 (see FIG. 4 and FIG. 5) between the inner cavity 5 and the outlet aperture 9, which is further sealed by an o-ring 23 situated between the perimetrical shoulder 24 of the plunger 21 and the outlet aperture 9. The first coiled compression spring 22 extends from the perimetrical shoulder 24 to a retaining ring 30 fitted into the inlet aperture 7 where the first coiled compression spring 22 is seated against the retaining ring 30. Pushing on an outlet end 25 of the plunger 21 causes the plunger 21 to move toward the retaining ring 30, which causes the first coiled compression spring 22 to compress and opens a gap between the plunger 21 and the wall 6 of the internal cavity 5. In such an open configuration, the fluid flow path between the inlet aperture 7 and the outlet aperture 9 is opened so that a working fluid can flow out of the internal cavity 5 through the outlet aperture 9. Releasing the pushing force permits the first coiled compression spring 22 to urge the plunger 21 back to the closed configuration.

The first valve 20 further comprises a longitudinal bore 27 extending therethrough between the inlet aperture 7 and the outlet aperture 9. A second valve 40 is located in the longitudinal bore 27, the second valve 40 comprising a ball 41, with a second coiled compression spring 42 seated on the ball 41. In a closed configuration as illustrated in FIG. 1, the ball 41 is seated on a narrowing portion 28 of the bore 27 to block a fluid flow path through the bore 27 between the inlet aperture 7 and the outlet aperture 9, which is further sealed by an o-ring 43 situated between the narrowing portion 28 and a press fit 44 in the outlet aperture 9, the press fit 44 being held in the outlet aperture 9 body by a snap ring 45 inserted onto the press fit 44. The snap ring 45 has holes therein to permit the working fluid to exit through the outlet aperture 9 and to permit valve body engagement elements to penetrate through the outlet aperture 9 to activate the valves 20 and 40. The second coiled compression spring 42 extends from the ball 41 to the retaining ring 30 where the second coiled compression spring 42 is seated against the retaining ring 30. Pushing on the ball 41 causes the ball 41 to move toward the retaining ring 30, which causes the second coiled compression spring 42 to compress and opens a gap between the ball 41 and the narrowing portion 28 of the bore 27. In such an open configuration, the fluid flow path between the inlet aperture 7 and the outlet aperture 9 is opened so that a working fluid can flow into the bore 27 from the inlet aperture 7. The ball 41 has a smaller diameter than an inner diameter of the bore 27 so that the working fluid can flow around the ball 41 in the bore 27. The working fluid can be allowed to flow out through the outlet aperture 9 directly or into a tube inserted through the outlet aperture 9 into the bore 27. Releasing the pushing force permits the second coiled compression spring 42 to urge the ball 21 back to the closed configuration.

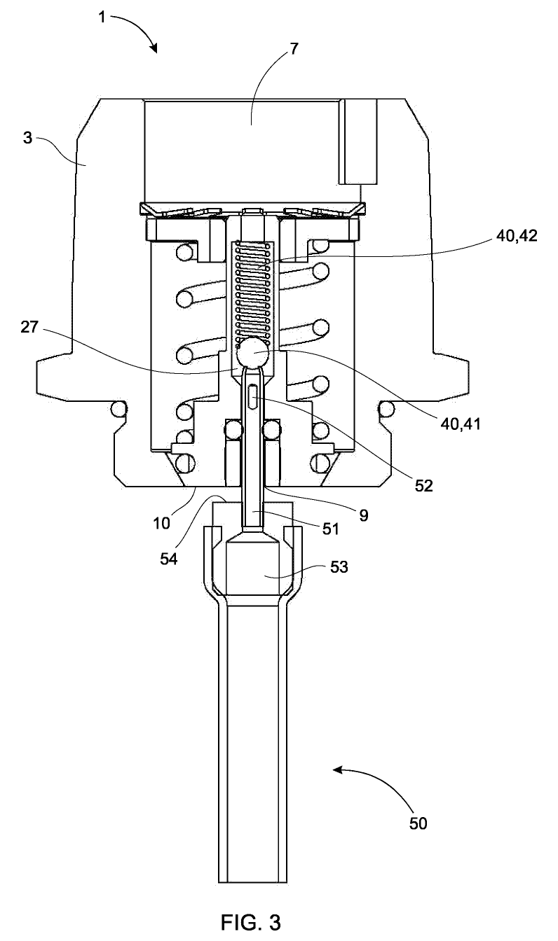

With reference to FIG. 3, FIG. 4 and FIG. 5, the fluid valve assembly 1 is shown together with probes 50, 60 and 70.

In FIG. 3, a probe 50 for a sampling device is shown being inserted through the outlet aperture 9 of the fluid valve assembly 1. The probe 50 has a narrow tube 51 that can be inserted through the outlet aperture 9 into the bore 27 to contact the ball 41 of the second valve 40 and push the ball 41 toward the inlet aperture 7 to open the second valve 40. A sample of working fluid flows from the inlet aperture 7 through the bore 27 past the ball 41 into a hole 52 in the tube 51. The tube 51 is connected to and in fluid communication with a hollow adapter 53 of the probe 50, which in turn is connected to and in fluid communication with a bottle (not shown) to collect the sample of working fluid. Removing the tube 51 from the bore 27 permits the second coiled compression spring 42 to return the ball 51 to the closed configuration. The adapter 53 has a flat face from which the tube 51 extends. The flat face is equipped with a face seal 54 that engages the flat end face 10 of the valve assembly body 3 around the outlet aperture 9 to create a seal between the probe 50 and the fluid valve assembly 1 once the tube 51 of the probe 50 is fully inserted into the bore 27.

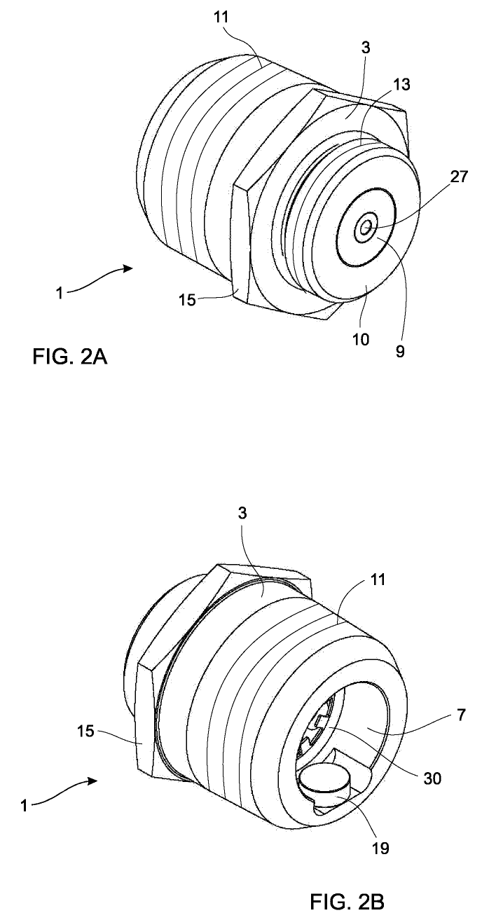

In FIG. 4, a probe 60 for a filtration device is shown screwed on to the fluid valve assembly 1 at the outlet aperture 9 of the fluid valve assembly 1. The probe 60 comprises a stem 61 that can be inserted through the outlet aperture 9 to contact the plunger 21 of the first valve 20 and push the plunger 21 toward the inlet aperture 7 to open the first valve 20, as seen in FIG. 4. Working fluid flows from the inlet aperture 7 through the fluid flow path 26 between the plunger 21 and the wall 6 of the internal cavity 5 to exit out the outlet aperture 9 into an internal volume 65 of the probe 60. The stem 61 is connected to a valve spacer 62 of the probe 60, which is seated on a coiled spring 63, which energizes the valve spacer 62 to push the stem 61 on the plunger 21 to open the first valve 20 when the probe 60 is screwed on to the second external screw threads 13 (see FIG. 2A and FIG. 2B) of the valve assembly body 3. Removing the probe 60 from the fluid valve assembly 1 permits the second coiled compression spring 22 to return the plunger 21 to the closed configuration. The probe 60 is equipped with an o-ring seal 64 to create a seal between the probe 60 and the fluid valve assembly 1. The external o-ring 17 provides a redundant seal to prevent leakage from the probe 60. The probe 60 has a quick connect coupler 66 to connect the probe 60 to the remaining components of the filtration device.

In FIG. 5, a probe 70 for a general purpose fluid handling device is shown screwed on to the fluid valve assembly 1 at the outlet aperture 9 of the fluid valve assembly 1. The probe 70 is the same as the probe 60 except that instead of a quick connect coupler, the probe 70 comprises a typical barbed hose connector 76.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A fluid valve assembly comprising:
a valve assembly body having an internal cavity with a fluid flow path from a first end to a second end of the path,
the valve assembly body at the first end configured to sealingly engage a fluid port from which a working fluid flows, the first end of the fluid flow path comprising an inlet aperture through which the working fluid flows into the internal cavity,
the valve assembly body at the second end configured to sealingly engage a fluid handling device, the second end of the fluid flow path having an outlet aperture through which the working fluid flows out of the internal cavity;
a first valve comprising: a first valve body movably disposed in the internal cavity; and, a first biasing element that biases the first valve body to sealingly seat the first valve body on a first seat in the internal cavity to prevent the working fluid in the internal cavity from flowing out the outlet aperture, the first valve body movable against the bias of the first biasing element to unseat the first valve body from the seat to permit the working fluid in the internal cavity to flow out the outlet aperture, the first valve body having a bore therethrough that fluidly connects the inlet aperture to the outlet aperture;
a second valve comprising: a second valve body movably disposed in the bore of the first valve body; and, a second biasing element that biases the second valve body to sealingly seat the second valve body on a second seat in the bore to prevent the working fluid in the bore from flowing out the outlet aperture, the second valve body movable against the bias of the second biasing element to unseat the second valve body from the second seat to permit the working fluid in the bore to flow out the outlet aperture.

2. The fluid valve assembly of claim 1, wherein the first valve body comprises a plunger.

3. The fluid valve assembly of claim 1, wherein the second valve body comprises a ball.

4. The fluid valve assembly of claim 1, wherein the first biasing element and/or the second biasing element comprises a spring.

5. The fluid valve assembly of claim 1, wherein the first biasing element and/or the second biasing element comprises a coiled spring.

6. The fluid valve assembly of claim 1, further comprising a retainer at the inlet aperture against which the first and second biasing elements are seated.

7. The fluid valve assembly of claim 6, wherein the retainer comprises a disc spanning a diameter of the inlet aperture, the disc having solid portions on which the first and second biasing elements are seated and open portions through which the working fluid flows into the internal cavity of the valve assembly body and the bore of the first valve body.

8. The fluid valve assembly of claim 1, wherein the sealings are accomplished with o-rings.

9. The fluid valve assembly of claim 1, further comprising a magnet situated at the inlet aperture.

10. The fluid valve assembly of claim 9, wherein the magnet is annular and surrounds a perimeter of the inlet aperture.

11. The fluid valve assembly of claim 1, wherein the valve assembly body is cylindrical at the first and second ends, the valve assembly body having first external screw threads around a side face at the first end of the fluid valve assembly to screw into complementary threads of the fluid port, the valve assembly body having second external screw threads around the side face at the second end of the fluid valve assembly to screw into complementary threads of the fluid handling device.

12. The fluid valve assembly of claim 1, wherein the valve assembly body has a flat end face for flush face engagement with the fluid handling device.

13. A system for fluid handling operations at a fluid port of a fluid-containing machine or container, the system comprising the fluid valve assembly of claim 1 and a probe of a fluid handling device, the probe sealingly engaged with the valve assembly body at the second end of the fluid flow path, the probe sealingly engageable with a remaining portion of the fluid handling device.

14. The system of claim 13, wherein the fluid handling device comprises a sampling device having a bottle sealingly engageable with the probe.

15. The system of claim 13, wherein the fluid handling device comprises a filtration device having a particle filter sealingly engageable with the probe and a fluid return sealingly engageable to another fluid port of the fluid-containing machine or container.
